(19) United States
(12) Patent Application Publication
(10) Pub. No.: US 2021/0304077 A1
(43) Pub. Date: Sep. 30, 2021

(54) METHOD AND SYSTEM FOR DAMAGE CLASSIFICATION

(71) Applicant: Sony Corporation, Tokyo (JP)

(72) Inventors: Hannes BERGKVIST, Tokyo (JP); Andreas PAULSSON, Tokyo (JP)

(21) Appl. No.: 17/266,956

(22) PCT Filed: Nov. 13, 2018
(86) PCT No.: PCT/IB2018/058924

§ 371 Date: Feb. 8, 2021

(51) Int. Cl. G06N 20/00; G01L 5/00; G01P 15/08; G06Q 30/00

(52) U.S. Cl. CPC G06N 20/00; G06Q 30/012; G01P 15/0891; G01L 5/0052

(57) ABSTRACT

A method for using machine learning techniques to analyze sensor data from an electronic device and to determine whether the data is associated with an out-of-warranty event.

### TECHNICAL FIELD

The present disclosure relates generally to machine learning techniques and, more particularly, to using a machine learning algorithm to classify damage to an electronic device.

### BACKGROUND

Currently, classification of damage to an electronic device under warranty is performed manually by ocular and mechanical inspection, e.g., at a retail location. If the retail location cannot make a classification, the electronic device may be sent to a service center (adding additional steps and time to the process). The service center or the retail location must determine whether damage is caused by consumer abuse or a design flaw. An exemplary issue faced by personnel at retail locations and service centers is deciding whether damage to a device is caused by a drop or comes from a scratch (i.e. no high impact). Other issues related to classifying damage to electronic devices are (1) training personnel to conduct the ocular inspection and (2) the variance in classification caused by subjective decisions of personnel.

### SUMMARY

As described above, ocular and mechanical inspection to classify damage as “out-of-warranty” or “in-warranty” is difficult, time consuming, and comes with high uncertainty. Accordingly, there is a need in the art for improved methods and systems related to warranty classification of electronic devices.

The present disclosures provides methods and systems for using machine learning techniques to classify and communicate whether damage to an electronic device is “in-warranty” or “out-of-warranty”.

Currently, an ocular and mechanical inspection may be used to determine whether damage to an electronic device is “in-warranty” versus “out of warranty” but said inspections do not take into consideration sensor data available from the electronic device. The present disclosure utilizes sensor data from the electronic device to improve the classification of damage to an electronic device as “in-warranty” or “out-of-warranty”.

According to one aspect, a method is provided for categorizing damage to a device using circuitry. The method includes receiving the sensor data from one or more sensors and classifying the sensor data by performing the following set of rules. Rule 1: access a machine learning algorithm. Rule 2: input the received sensor data into the machine learning algorithm. Rule 3: execute the machine learning algorithm to classify the received sensor data as an “in-warranty” state or an “out-of-warranty” state. The method also includes causing the circuitry to output electronic data indicating the category of the sensor data. The electronic data indicates whether the machine learning algorithm classified the received sensor data as being associated with an “in-warranty” state or an “out-of-warranty” state.

Alternatively or additionally, the method may include detecting a wake-up event associated with at least one sensor of the one or more sensors. In response to the wake-up event, the method may include storing the sensor data, activating the one or more sensors to begin capturing the sensor data, increasing a sampling rate of the one or more sensors, buffering data associated with the one or more sensors by a memory accessible by the circuitry or accessing stored data. In some embodiments, the wake-up event may be associated with a false-positive rich threshold value such that sensor data associated with the “in-warranty” state is stored upon the wake-up event being detected.

Alternatively or additionally, the one or more sensors may be physically associated with the device and the circuitry classifying the sensor data may be physically associated with a separate electronic device remote from the device and may receive the sensor data via a network.

Alternatively or additionally, accessing the machine learning algorithm may include training the machine learning algorithm. Training the machine learning algorithm may include receiving labeled in-warranty sensor data and receiving labeled out-of-warranty sensor data. Training the machine learning algorithm may further include configuring the machine learning algorithm, such that when labeled “in-warranty” sensor data is input to the machine learning algorithm, the machine learning algorithm classifies the labeled “in-warranty” sensor data as being the “in-warranty” state and when the labeled “out-of-warranty” sensor data is input to the machine learning algorithm, the machine learning algorithm classifies the labeled “out-of-warranty” sensor data as being the “out-of-warranty” state. Thereafter, the labeled “in-warranty” sensor data and the labeled “out-of-warranty” sensor data may be used to train the machine learning algorithm.

Alternatively or additionally, the method for categorizing damage may include determining that the sensor data satisfies a threshold value and, thereafter, performing the classification of the sensor data.

Alternatively or additionally, the one or more sensors comprise at least one of an accelerometer, a magnetometer, a proximity sensor, a gyro, a temperature sensor, a barometer, application data, a microphone, a touch screen sensor, a pressure sensor, and a biometric sensor.

According to another aspect, an electronic device is provided for categorizing damage based on sensor data received from one or more sensors. The electronic device includes a memory comprising a non-transitory computer readable medium storing a machine learning algorithm. The electronic device also includes circuitry configured to receive the sensor data from the one or more sensors and classify the sensor data as an “in-warranty” state or an “out-of-warranty” state by executing the following rules. Rule 1: accessing the stored machine learning algorithm. Rule 2: inputting the received sensor data into the machine learning algorithm. Rule 3: executing the machine learning algorithm to classify the received sensor data as the “in-warranty” state or the “out-of-warranty” state. The circuitry is also configured to output electronic data indicating the state of the sensor data.

Alternatively or additionally, the device may further include detecting a wake-up event associated with at least one sensor of the one or more sensors. In response to the wake-up event, the device may be configured to store the sensor data, activate the one or more sensors to begin capturing the sensor data, increase a sampling rate of the one or more sensors, buffer data associated with the one or more sensors by a memory accessible by the circuitry or accessing stored data. In some embodiments, the wake-up event may be associated with a false-positive rich threshold value such that sensor data associated with the “in-warranty” state is stored upon the wake-up event being detected.

Alternatively or additionally, the electronic device may further comprise the one or more sensors and the circuitry configured to classify the sensor data may be physically associated with a separate electronic device remote from the device and the separate electronic device may receive the sensor data via a network.

Alternatively or additionally, accessing the machine learning algorithm may include training the machine learning algorithm. Training the machine learning algorithm may include receiving labeled in-warranty sensor data and receiving labeled out-of-warranty sensor data. Training the machine learning algorithm may further include configuring the machine learning algorithm, such that when labeled “in-warranty” sensor data is input to the machine learning algorithm, the machine learning algorithm classifies the labeled “in-warranty” sensor data as being the “in-warranty” state and when the labeled “out-of-warranty” sensor data is input to the machine learning algorithm, the machine learning algorithm classifies the labeled “out-of-warranty” sensor data as being the “out-of-warranty” state. Thereafter, the labeled “in-warranty” sensor data and the labeled “out-of-warranty” sensor data may be used to train the machine learning algorithm.

Alternatively or additionally, the electronic device for categorizing damage may include circuitry that determines that the sensor data satisfies a threshold value and, thereafter, performs the classification of the sensor data.

Alternatively or additionally, the one or more sensors comprise at least one of an accelerometer, a magnetometer, a proximity sensor, a gyro, a temperature sensor, a barometer, application data, a microphone, a touch screen sensor, a pressure sensor, and a biometric sensor.

While a number of features are described herein with respect to embodiments of the invention, features described with respect to a given embodiment also may be employed in connection with other embodiments. The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is a schematic diagram of an exemplary electronic device according to an exemplary embodiment of the invention.

FIG. 2 is a ladder diagram depicting movement of information according to an exemplary embodiment of the invention.

FIG. 3 is a block diagram depicting training of the machine learning algorithm according to an exemplary embodiment of the invention.

FIG. 4 is a block diagram depicting classification of sensor data by the machine learning algorithm according to an exemplary embodiment of the invention.

FIG. 5 is a schematic diagram of an exemplary mobile device according to an exemplary embodiment of the invention.

FIG. 6 is a flow diagram of a method for providing a warranty classification using a machine learning algorithm according to an exemplary embodiment of the invention.

### DETAILED DESCRIPTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

The present invention provides a device including circuitry and memory. The circuitry uses machine learning techniques to analyze sensor data that is stored in the memory. The circuitry outputs a warranty classification based on the sensor data regarding whether the data corresponds to an “in-warranty” state or an “out-of-warranty” state of an associated device. The sensor data may be provided by sensors in an electronic device such as a mobile phone, tablet computer, gaming controller, television, a smart speaker, and the like. The electronic device may detect an event such as a drop and use a classifier, for example a machine learning algorithm, to classify the event as associated with damage that would be within or outside of a warranty. A machine learning algorithm may be trained using existing sensor data for each electronic device. There are, for example, numerous benefits including reducing delays to the consumer for warranty classification and providing increased warranty protection due to the reduction in false “in-warranty” classifications for damage caused by “out-of-warranty” events.

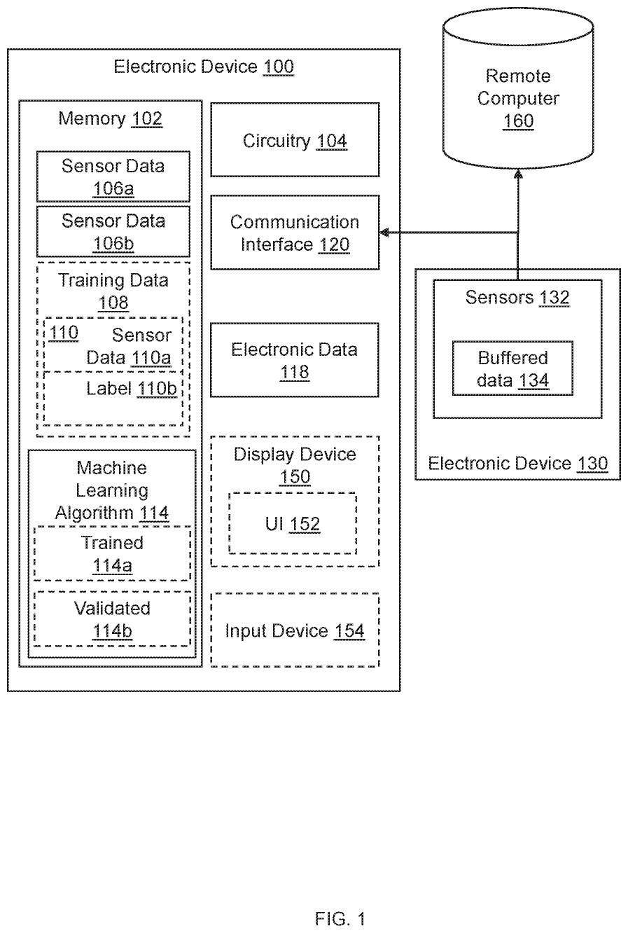

Turning to FIG. 1, a schematic diagram of an exemplary electronic device according to the invention is shown. The device 100 includes memory 102 and circuitry 104. The device 100 may also include a communication interface 120, a display device 150, a user interface 152, and/or an input device 154. The memory 102 stores sensor data 106 received from one or more sensors 132. In some embodiments, the one or more sensors 132 may be associated with a second electronic device 130. The sensor data 106 may include buffered data 134 associated with events prior to the instant sensor data. In some embodiments, the memory 102 may include training data 108 consisting of input-output pairs 110. The input-output pairs 110 may include sensor data 110a and an associated label 110b that indicates whether sensor data 110a was collected for an “in-warranty” event or an “out-of-warranty” event.

The memory 102 includes a machine learning algorithm 114 that may be referred to as a trained machine learning algorithm 114a after the machine learning algorithm 114 has been trained (as is described in further detail below). The machine learning algorithm 114 may also be referred to as a validated machine learning algorithm 114b when the machine learning algorithm 114 has been validated (as is described in further detail below). The machine learning algorithm 114 classifies an input (e.g., sensor data 106) as a particular warranty classification (e.g., in-warranty state or an out-of-warranty state) and outputs electronic data 118. The electronic data 118 indicates a warranty state such as “in-warranty” or “out-of-warranty” and may include sensor data used for the classification. In some embodiments, the machine learning algorithm 114 may be replaced with one or more rules configured to determine the warranty state based on sensor data 106. Furthermore, the rules and/or the machine learning algorithm 114 may be updated using sensor data 106, the user interface 152, the remote computer 160, and the like (as is described in further detail below). The device 100 can be configured with the machine learning algorithm 114 and/or the set of rules before shipment to a consumer. In some embodiments, the device 100 may be configured for a consumer to download the machine learning algorithm 114 and/or the set of rules.

For example, the circuitry 104 may access the machine learning algorithm 114 (also referred to as a warranty classification machine learning algorithm) and sensor data 106. The sensor data 106 may include data such as accelerometer data and microphone data associated with a drop event. The circuitry 104 may input the sensor data 106 into the machine learning algorithm 114. The circuitry 104 may execute the machine learning algorithm 114 to classify the sensor data 106 as being associated with an “in-warranty” state or an “out-of-warranty” state. In some embodiments, one or more of the sensor data 106 and the machine learning algorithm 114 may be received by the electronic device 100 from a remote computer 160. The development and deployment of the machine learning algorithm 114 may include three stages: (1) Data acquisition, (2) Training, and (3) Classification.

### I. Data Acquisition

A magnitude of events, such as drops and other impacts may be performed on one or several test devices while collecting sensor data 106. That is, test devices (e.g., mobile phones) may be dropped or abused in ways corresponding to out of warranty events that typically occur when the test devices are used by customers. Each event may be labeled as “in-warranty” (e.g., a “0”) or “out-of-warranty” (e.g., a “1”). That is, because the events are being purposely performed, it is know whether the event is an out of warranty event or an “in-warranty” event. In this way, sensor data collected during an “in-warranty” event may be characterized as being associated with an “in-warranty” event (e.g., a design flaw). Conversely, sensor data collected during an “out-of-warranty” event may be characterized as being associated with an “out-of-warranty” event (e.g., customer abuse).

As will be understood by one of ordinary skill in the art, the events (i.e., dropping the phone, etc.) may be caused manually or using a robot to achieve well defined “events”. Sensor data 106 may be collected for each of the events and used to train the machine learning algorithm. The events may also be performed for each electronic device on which a machine learning algorithm 114 is to be deployed.

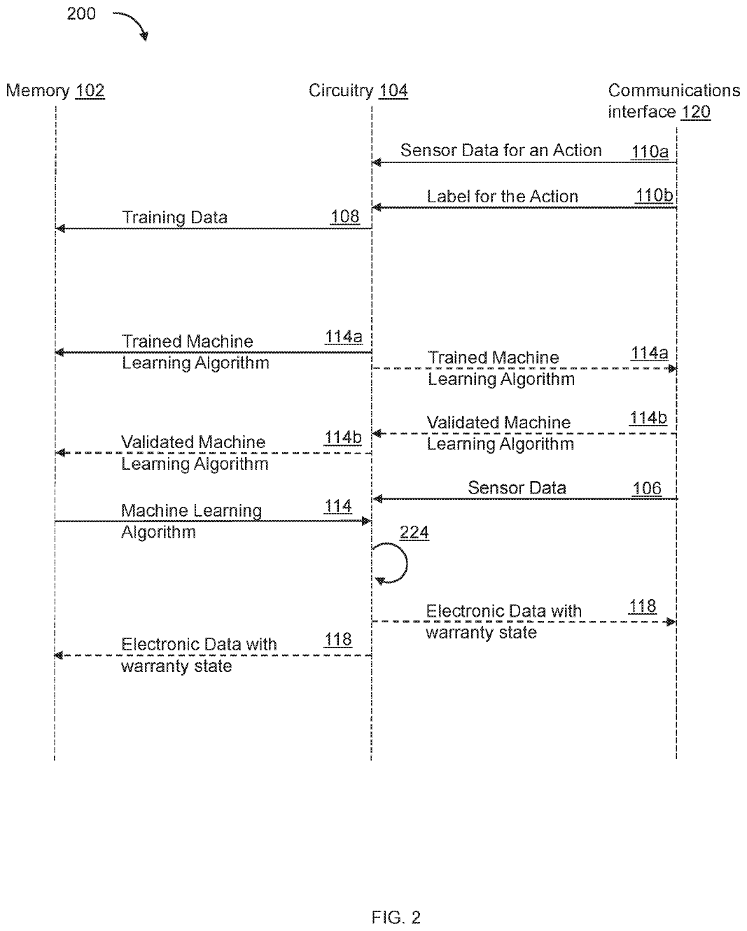

FIG. 2 is a ladder diagram 200 depicting movement of information according to the invention. The circuitry 104 may receive sensor data 110a from the one or more sensors 132 through communications interface 120. The sensors 132 may include at least one or more of an accelerometer, a magnetometer, a proximity sensor, a gyro, a temperature sensor, a barometer, application data, a microphone, a touch screen sensor, a pressure sensor, a biometric sensor, a water sensor (e.g., a humidity sensor), or any suitable sensor for detecting forces experienced by the device 100. The sensor data 110a may be collected during device testing such as free-fall drop tests, impact tests, compression tests, vibration tests, and the like.

During device testing, any damage to the device may be labeled as an “in-warranty” event or an “out-of-warranty” event. The circuitry 104 may receive the label 110b assigned to the data during device testing for the received sensor data 110a. The circuitry 104 may store the received sensor data 110a and label 110b as an input-output pair 110 in memory 102 for use by the machine learning algorithm 114. In some embodiments, the sensor data 110a and label 110b may be received separately (as shown in FIG. 2) and combined. Alternatively, the circuitry 104 may receive input-output pairs 110 directly from a remote device via the communications interface 120. In some embodiments, the circuitry 104 may be configured to receive additional labeled sensor data 110 (also referred to as an in-output pair) to improve the machine learning algorithm 114.

The ladder diagram 200 also shows data acquisition by the circuitry 104 after a trained machine learning algorithm 114a had been deployed. The circuitry 104 may receive sensor data 106 from communications interface 120. In some embodiments, described further herein, sensor data 106 may be recorded by sensors 132 associated with the electronic device 100 that includes circuitry 104.

### II. Training

After receiving training data 108 that includes sensor data 110a and, if available, a label 110b for a particular event, the circuitry trains the machine learning algorithm 114 using the training data 108. As will be understood by one of ordinary skill in the art, the machine learning algorithm 114 may be any suitable machine learning algorithm suitable for classifying data. For example, the machine learning algorithm 114 may comprise a neural network such as a bidirectional recurrent neural network, a support vector machine, linear regression, logistic regression, and the like. In some embodiments, a combination of machine learning algorithms may be used. The machine learning algorithm may be trained using supervised learning, unsupervised learning, labeled data, or unlabeled data. For example, the machine learning algorithm may be trained using unlabeled data collected during real world usage of the device. In some embodiments, statistical methods may be used to classify sensor data.

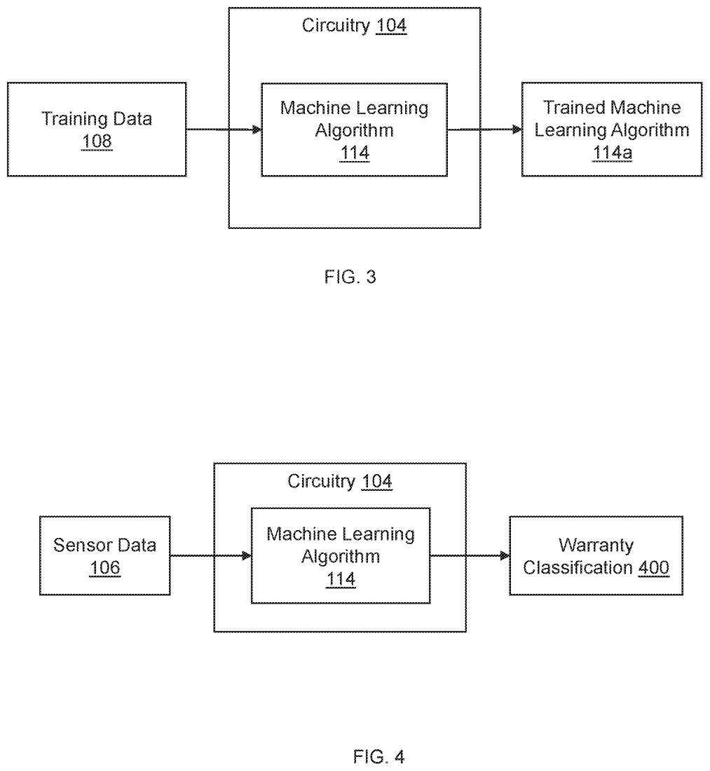

Turning to FIGS. 2 and 3, a block diagram depicting training of the machine learning algorithm is shown. Training of the machine learning algorithm may include the circuitry 104 accessing the training data 108. The circuitry 104 may receive the training data 108 with input-output pairs including labeled “in-warranty” sensor data and labeled “out-of-warranty” sensor data from the memory 102 or via the communications interface 120. The circuitry 104 uses the training data 108 to configure the machine learning algorithm 114 such that, when labeled “in-warranty” sensor data is input to the machine learning algorithm 114, the machine learning algorithm 114 classifies the labeled “in-warranty” sensor data as being associated with an “in-warranty” state. The circuitry 104 also uses the training data 108 to configure the machine learning algorithm such that, when the labeled “out-of-warranty” sensor data is input to the machine learning algorithm, the machine learning algorithm classifies the labeled “out-of-warranty” sensor data as being associated with an “out-of-warranty” event. After processing the training data 108, the circuitry 104 stores a trained machine learning algorithm 114a in memory 102. As described above, the trained machine learning algorithm 114a classifies sensor data 106 as being associated with an “in warranty” event or an “out-of-warranty” event.

With continued reference to FIG. 2, the trained machine learning algorithm 114a may be stored in memory 102 for use at a later time, access by other devices, additional training, etc. The trained machine learning algorithm 114a may also be validated. The validation may include providing sensor data 106 to the trained machine learning algorithm 114a and using the trained machine learning algorithm 114a to classify the received sensor data 106 as being associated with an “in-warranty” state or an “out-of-warranty” state of a device. A trained machine learning algorithm 114a may be considered as validated when the output of the trained model correctly classifies sensor data to a known warranty state at a desired rate. For example, the desired rate may be an accuracy of 90%, 95%, 98%, 99%, or any other suitable accuracy. When the trained machine learning algorithm 114a is validated as accurate, the machine learning algorithm 114a may be labeled as validated 114b and used for classification. Alternatively, if the accuracy of the model is not sufficient, the circuitry 104 may collect more data and continue to improve the model until the model is sufficiently accurate to be labeled as validated. In some embodiments, training and validation of the machine learning algorithm 114 may be performed on a remote computing device and the circuitry 104 may receive a validated model from the remote computing device. The circuitry may store the validated model in memory 102 to be used for classification of sensor data.

As will be understood by one of ordinary skill in the art, validation of the machine learning algorithm 114 may be performed during training. That is, validation of the trained machine learning algorithm may not be necessary. Instead, the machine learning algorithm may be validated during training such that the machine learning algorithm is not labeled as trained until the machine learning algorithm is sufficiently accurate.

### III. Classification

The machine learning algorithm 114 may be deployed on electronic devices for classification of events associated with damage to a device. For example, during everyday customer usage scenarios, sensor data 106 may be collected locally on the device. The collected sensor data 106 may be stored locally on the device or remotely (e.g., on a server). In some embodiments, one or more low power sensors may record sensor data 106 when the device is powered off, in a deep-sleep mode, and any other low-power stand-by modes. The circuitry 104 may access the validated model of the machine learning algorithm 114 and use the machine learning algorithm 114 to classify the sensor data as associated with an “out-of-warranty” event or an “in-warranty” event (i.e., classifying any resulting damages to the electronic device as the device state being an “in-warranty” state or an “out-of-warranty” state). The circuitry 104 may store the results of the classification (i.e., as “in-warranty” or “out-of-warranty”) in memory 102, display the results on a display device 150, and/or transmit the results of the classification via the communications interface 120 (e.g., to another device).

FIG. 4 is a block diagram depicting classification of sensor data by the machine learning algorithm 114. Once deployed, the circuitry 104 executing the trained machine learning algorithm 114a may provide warranty classification 400 for sensor data 106 (e.g., associated with an event). Events may include detecting any forces acting on the associated device that cause the sensor data to exceed a threshold value. For example, dropping the electronic device 100 from a height of one meter onto concrete may result in a sensed acceleration (i.e., deceleration) that is greater than the threshold value, while dropping the electronic device 100 from a height of one meter onto a pillow may not result in a sensed acceleration that is greater than the threshold. In addition to acceleration, a drop may result in pressure or force data from a touch screen that exceeds a threshold determined for normal operation. Additionally, a drop may cause vibrations or a sound that saturates the microphone or results in a detected sound having particular properties (e.g., above a particular decibel). In this way, a threshold may be determined for microphone data that indicates a drop occurred. In some embodiments, the sensor data may include features extracted from a signal by a wake-up-word system on a mobile device that indicate an event such as a drop. The machine learning algorithm classification may use a complex function that combines time series data from one or more sensors to classify the received sensor data as an being associated with an “in-warranty” state or an “out-of-warranty” state.

An event that exceeds the threshold value may be a wake-up event that causes the circuitry 104 to perform additional steps before executing the machine learning algorithm to classify the sensor data (also referred to as “warranty classification”). In response to a wake-up event, the circuitry 104 may store the sensor data in memory, activate one or more additional sensors to begin capturing the sensor data, increase a sampling rate of one or more sensors, buffer data associated with one or more sensors, access stored data, and the like. For example, the sensors 132 may store data in a buffer during normal operation. During normal operation, the buffered sensor data may be deleted as the buffer fills (e.g., a first in first out buffer) or after a given duration of time (e.g., 10 seconds after the sensor data is recorded). Upon the wake-up event occurring, the buffer may stop deleting recorded sensor data and may instead store the already buffered sensor data as well as any sensor data output by the sensors for a period of time (e.g., 10 seconds) after the wake-up event occurred.

The stored sensor data 106 may include sensor data buffered by individual sensors, such as audio buffered to detect a wake word or historical motion data stored by a 6-axis sensor. For example, the circuitry 104 may detect a wake-up event using accelerometer data (e.g., the device being dropped) and, after the wake-up event, the circuitry may access additional sensor data such as microphone data, pressure data, the current application, and the like. In some embodiments, the circuitry 104 may store the data from additional sensors after the wake-up event. For example, the acceleration may exceed a threshold value and, in response, the circuitry 104 may increase the sampling rate of the accelerometer, gyroscope, and magnetometer and store the data for processing by the machine learning algorithm 114. In another embodiment, the circuitry may access buffered audio data after detecting a wake-up event. Additionally or alternatively, the circuitry 104 may access the current application executing on the phone. For example, the device may determine a drop is more likely to occur when particular types of applications have focus (e.g., a game that uses motion inputs versus an application used for reading email).

After inputting received sensor data into the machine learning algorithm 114, the circuitry 104 may execute the machine learning algorithm 114 to classify the received sensor data as an “in-warranty” state or an “out-of-warranty” state and output electronic data 118 indicating the state of the sensor data (e.g., in warranty or out of warranty). Outputting the electronic data 118 may comprise at least one of displaying on the display device 150 the state of the sensor data on a user interface 152 (e.g., such as an app on a mobile device), recording the electronic data 118 in memory, or transmitting the electronic data 118 via the communication interface 120. The warranty state 400 indicates an “in-warranty” state or an “out-of-warranty” state and may be presented to the user of the electronic device, a service technician, or both. The electronic data 118 may be displayed in a support application on a mobile device or a remote computer such as a service technician workstation. The support application may display the current warranty state, a time remaining on one or more warranties, and any events classified by the machine learning algorithm 114 along with the date and time of the event.

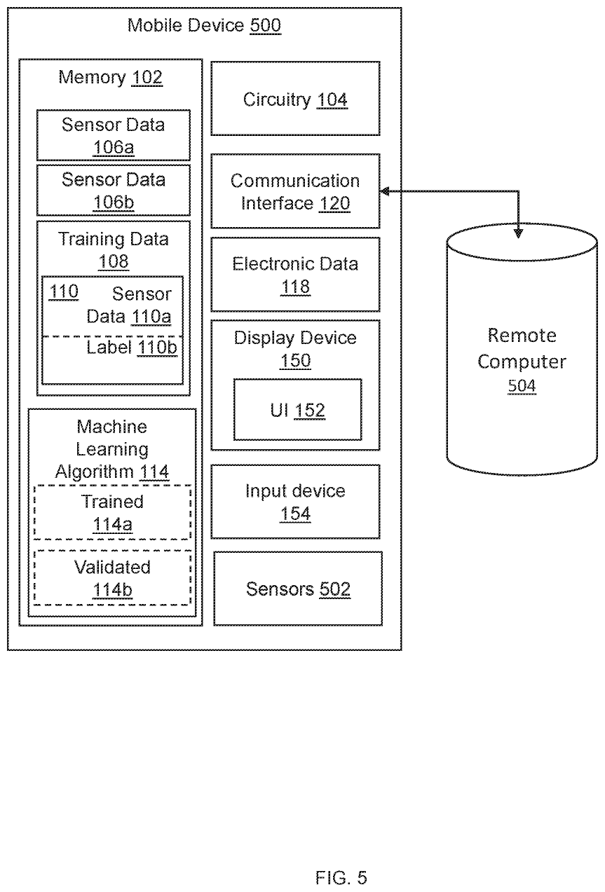

FIG. 5 is a schematic diagram of an exemplary mobile device according to the invention. The mobile device 500 may include a memory 102, circuitry 104, electronic data 118, a communications interface 120, a display device 150, an input device 154, and sensors 502. The sensors 502 may include an accelerometer, a magnetometer, a proximity sensor, a gyro, a temperature sensor, a barometer, application data, a microphone, a touch screen sensor, a pressure sensor, a biometric sensor, or any other suitable device for sensing forces experienced by the mobile device 500. The sensors 502 may include one or more low power sensors may record sensor data 106 when the device is in a deep-sleep mode, powered off, and any other low-power stand-by modes. The machine learning algorithm 114 can be configured to process and/or transmit any data collected during a low-power stand-by mode when the device returns to normal operation. Additionally, the sensors 502 may be configured to continue collecting data when a power source is connected to the mobile device 500. The sensors 502 may be integrated with the mobile device 500 and accessed by the circuitry 104. In some embodiments, the mobile device 500 may be coupled to a remote computer 504 such as a cloud server, a service technician workstation, or the like.

The circuitry 104 may access the machine learning algorithm 114 in memory 102. The machine learning algorithm 114 may cause the circuitry 104 of the mobile device 500 to execute a plurality of rules. The circuitry 104 may receive and store sensor data 106 in memory 102 as required. For example, the circuitry may monitor sensor data until it detects a wake-up event associated with at least one sensor of the one or more sensors. After detecting a wake-up event, the circuitry 104 may store sensor data 106 from the sensors 502 for processing by the machine learning algorithm 114. The wake-up event may be associated with a false-positive rich threshold value, such that sensor data associated with an “in-warranty” state is stored upon the wake-up event being detected. A false-positive rich threshold value may be set to include sensor data that may not be associated with an event such as a fall that lands on a soft surface that may not cause damage to the mobile device 500.

In some embodiments, the circuitry 104 may start sampling sensor data when triggered by interrupt of critical level on one or several sensors. In some embodiments, the machine learning algorithm 114 may cause the circuitry 104 to classify the sensor data in real-time or near real-time, store the warranty state, and delete the sensor data. According to another embodiment, the machine learning algorithm 114 may cause the circuitry 104 to store the sensor data and only classify when requested to do so via, for example, input device 154. The input device 154 may receive input from a user interface 152 or the remote computer 504. The request may be entered by a consumer or, in some embodiments, limited to a service technician. In some embodiments, the machine learning algorithm 114 may cause the circuitry 104 to store the sensor data and transmit the sensor data to the remote computer 504 for classification. The mobile device 500 may receive the warranty classification. In some embodiments, mobile device 500 may be configured to restrict access to the warranty classification to authorized users such as a service technician. In an alternate embodiment, an authorized user may access the warranty classification on the remote computer 504.

The user interface 152 may display the warranty state and associated sensor data directly to a user to provide warranty information. In some embodiments, an initial classification may be provided to the user via the user interface 152. The initial classification may use a first subset of sensor data 106a. A second subset of sensor data 106b may be transmitted to the remote computer 504 for classification using a more complex machine learning model. For example, the second subset of sensor data 106b may include a larger dataset from a larger number of sensors that would be computationally intensive for mobile device 500 to classify.

In some embodiments, the first subset of sensor data 106a may be current sensor data and the second subset of sensor data 106b may be historical sensor data. The machine learning algorithm 114 may determine a warranty state using the first subset of sensor data 106a and the second subset of sensor data 106b. For example, time series sensor data such as microphone data may include current sensor data and historical sensor data; using the historical sensor data may increase the available input to the machine learning algorithm 114 and thus improve accuracy of the warranty classification.

According to another embodiment, the mobile device may receive the machine learning algorithm 114 via the communications interface from the remote computer 504. The data and computationally intensive training may be performed on the remote computer 504 and, once validated, the machine learning algorithm 114 may be deployed to the mobile device 504.

As will be understood by one of ordinary skill in the art, the circuitry 104 may have various implementations. For example, the circuitry 104 may include any suitable device, such as a processor (e.g., CPU), programmable circuit, integrated circuit, memory and I/O circuits, an application specific integrated circuit, microcontroller, complex programmable logic device, other programmable circuits, or the like. The circuitry 104 may also include a non-transitory computer readable medium, such as random access memory (RAM), a read-only memory (ROM), an erasable programmable read-only memory (EPROM or Flash memory), or any other suitable medium. Instructions for performing the method 600 described below may be stored in the non-transitory computer readable medium and executed by the circuitry 104. The circuitry 104 may be communicatively coupled to the memory 102 and a communication interface 120 through a system bus, mother board, or using any other suitable structure known in the art.

The mobile device 500 may also include a display device 150. The circuitry 104 may be configured to cause the display device 150 to display the electronic data 118. The electronic data 118 may include the warranty state, i.e., “in-warranty” or “out-of-warranty”. For example, the circuitry 104 may be further configured to cause the display device 150 to display along with the warranty state at least one or more values associated with the sensor data indicating why the event was classified as in-warranty” or “out-of-warranty”. In this way, a consumer or service technician reviewing the warranty classification may view the sensor data 106 needed to make an informed decision regarding granting or denying warranty replacement of the mobile device 500.

As will be understood by one of ordinary skill in the art, the display device 150 may have various implementations. For example, the display device 150 may comprise any suitable device for displaying information, such as a liquid crystal display, light emitting diode display, a CRT display, an organic light emitting diode (OLED) display, a computer monitor, a television, a phone screen, or the like. The display device 150 may also include an interface (e.g., HDMI input, USB input, etc.) for receiving information to be displayed.

The mobile device 500 may also include an input device 154 for receiving an input from a user of the mobile device 500. For example, when displaying the warranty state, the user interface 152 may include an input for selecting “in-warranty” or “out-of-warranty” service. The circuitry 104 may be configured to receive the selected input device 154 and prepare electronic data 118 in accordance with the received input device 154. The circuitry 104 may then cause the communication interface 120 to transmit the electronic data 118 to the remote computer 504.

As the machine learning algorithm 114 classifies the received sensor data, the warranty states associated with each event may be stored in memory 102 and transmitted to the remote computer 504. The saved classifications may be used by the circuitry 104 or the remote computer 504 for additional training of the machine learning algorithm 114. In this way, performance of the machine learning algorithm 114 may be continuously or periodically updated. For example, the machine learning algorithm 114 may be updated daily, weekly, monthly, or based on the number warranty classifications executed (e.g., every 100, 250, or 1000).

As will be understood by one of ordinary skill in the art, the input device 154 may have various implementations. For example, the input device 154 may comprise any suitable device for inputting data into an electronic device, such as a keyboard, mouse, trackpad, touch screen (e.g., as part of the display device 150, including pressure), microphone, and the like.

As will be understood by one of ordinary skill in the art, the communication interface 120 may comprise a wireless network adaptor, an Ethernet network card, or any suitable device that provides an interface between the mobile device 500 and a network. The communication interface 120 may be communicatively coupled to the memory 102, such that the communication interface 120 is able to send data stored on the memory 102 across the network and store received data on the memory 102. The communication interface 120 may also be communicatively coupled to the circuitry 104 such that the circuitry 104 is able to control operation of the communication interface 120. The communication interface 120, memory 102, and circuitry 104 may be communicatively coupled through a system bus, mother board, or using any other suitable manner as will be understood by one of ordinary skill in the art.

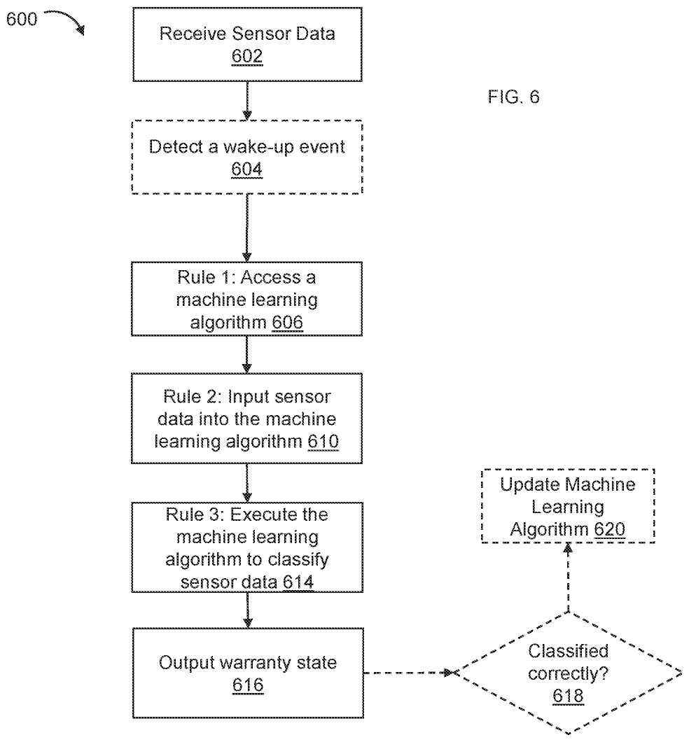

Turning to FIG. 6, a flow diagram of a method for providing a warranty classification using a machine learning algorithm according to the invention is shown.

In reference block 602, the circuitry 104 receives sensor data from one or more sensors. In optional reference block 604, the circuitry 104 may detect a wake-up event in the sensor data and begin storing additional sensor data, activate one or more sensors to begin capturing the sensor data, increase a sampling rate of one or more sensors, buffer data associated with one or more sensors by a memory accessible by the circuitry; or access additional stored data. The sensors may include one or more low power sensors may record sensor data when the device is in a deep-sleep mode, powered off, and any other low-power stand-by modes. In some embodiments, the device may be configured to classify the data in the stand-by mode. The machine learning algorithm can be configured to process and/or transmit any data collected during a low-power stand-by mode when the device returns to normal operation. As described above, the sensor data may be associated with one or more of an accelerometer, a magnetometer, a proximity sensor, a gyro, a temperature sensor, a barometer, application data, a microphone, a touch screen sensor, a pressure sensor, and a biometric sensor. In reference blocks 606-614, the circuitry determines a warranty state by executing a plurality of rules.

In reference block 606, the circuitry 104 accesses a machine learning algorithm such as the machine learning algorithm described herein. In reference block 610, the circuitry inputs sensor data into the machine learning algorithm. The sensor data may be associated with an event such as a drop that caused one or more forces to be applied to a device. In reference block 614, the circuitry 104 executes the machine learning algorithm to classify the sensor data as being associated with an “in-warranty” state or an “out-of-warranty” state.

In reference block 616, the circuitry 104 may generate and output electronic data indicating the warranty state associated with the sensor data. The outputting may include outputting the warranty state to a user interface and/or a remote device. In some embodiments, the electronic data may include the sensor data used to determine the warranty state.

In some embodiments, at reference block 618, the electronic device may be examined by a service technician (e.g., optically checking for dents, scratches, cracks, etc.) to determine whether the warranty state and sensor data were classified correctly by the machine learning algorithm. In reference block 620 a machine learning algorithm may be updated with new input-output pairs of training data generated by reference blocks 602-616.

It should be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer readable media, or a combination of a hardware circuit(s) and a processor and/or control block executing such code.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method performed by circuitry for categorizing damage to a device, the method comprising:
receiving the sensor data from one or more sensors;
classifying the sensor data by performing the following rules:
rule 1: accessing a machine learning algorithm;
rule 2: inputting the received sensor data into the machine learning algorithm; and
rule 3: executing the machine learning algorithm to classify the received sensor data as an in-warranty state or an out-of-warranty state; and
outputting electronic data indicating the state of the sensor data.

2. The method of claim 1, wherein receiving the sensor data from the one or more sensors further comprises:
detecting a wake-up event associated with at least one sensor of the one or more sensors; and
thereafter, storing the sensor data, comprising at least one of:
activating the one or more sensors to begin capturing the sensor data;
increasing a sampling rate of the one or more sensors;
buffering data associated with the one or more sensors by a memory accessible by the circuitry; or
accessing stored data.

3. The method of claim 2 wherein the wake-up event is associated with a false-positive rich threshold value, such that sensor data associated with the in-warranty state is stored upon the wake-up event being detected.

4. The method of claim 1, wherein:
the one or more sensors are physically associated with the device;
the circuitry is physically associated with a separate electronic device remote from the device; and
the circuitry receives the sensor data via a network.

5. The method of claim 1 wherein:
accessing the machine learning algorithm in rule 1 further comprises training the machine learning algorithm; and
the training of the machine learning algorithm comprises:
receiving labeled in-warranty sensor data;
receiving labeled out-of-warranty sensor data;
configuring the machine learning algorithm, such that:
when labeled “in-warranty” sensor data is input to the machine learning algorithm, the machine learning algorithm classifies the labeled “in-warranty” sensor data as being the “in-warranty” state;
when the labeled “out-of-warranty” sensor data is input to the machine learning algorithm, the machine learning algorithm classifies the labeled “out-of-warranty” sensor data as being the “out-of-warranty” state; and
training the machine learning algorithm using the labeled “in-warranty” sensor data and the labeled “out-of-warranty” sensor data.

6. The method of claim 1 further comprises:
determining that the sensor data satisfies a threshold value; and
thereafter, performing the classification of the sensor data.

7. The method of claim 1 wherein the one or more sensors comprise at least one of an accelerometer, a magnetometer, a proximity sensor, a gyro, a temperature sensor, a barometer, application data, a microphone, a touch screen sensor, a pressure sensor, and a biometric sensor.

8. An electronic device for categorizing damage based on sensor data received from one or more sensors, the electronic device comprising:
memory comprising a non-transitory computer readable medium storing a machine learning algorithm;
circuitry configured to:
receive the sensor data from the one or more sensors;
classify the sensor data as an “in-warranty” state or an “out-of-warranty” state comprising performing the following rules:
rule 1: accessing the stored machine learning algorithm;
rule 2: inputting the received sensor data into the machine learning algorithm; and
rule 3; executing the machine learning algorithm to classify the received sensor data as the in-warranty state or the out-of-warranty; and output electronic data indicating the category of the sensor data.

9. The electronic device of claim 8 wherein the circuitry configured to receive the sensor data from the one or more sensors further comprises:
detecting a wake-up event associated with at least one sensor of the one or more sensors; and
thereafter, causing the sensor data to be stored, comprising at least one of:
activating the one or more sensors to begin capturing the sensor data;
increasing a sampling rate of the one or more sensors;
buffering data associated with the one or more sensors by a memory accessible by the circuitry; or
accessing historical sensor data stored in the memory before the wake-up event.

10. The electronic device of claim 9, wherein the wake-up event is associated with a false-positive rich threshold value, such that sensor data associated with the in-warranty state is stored upon the wake-up event being detected.

11. The electronic device of claim 8, further comprising the one or more sensors.

12. The electronic device of claim 8, wherein the one or more sensors are located on another device separate from the circuitry and the circuitry receives the sensor data via a network.

13. The electronic device of claim 8 wherein:
accessing the machine learning algorithm in rule 1 further comprises training the machine learning algorithm; and
the training of the machine learning algorithm comprises:
receiving labeled in-warranty sensor data;
receiving labeled out-of-warranty sensor data;
configuring the machine learning algorithm, such that:
when the labeled in-warranty sensor data is input to the machine learning algorithm, the machine learning algorithm classifies the labeled in-warranty sensor data as being the in-warranty state;
when the labeled out-of-warranty sensor data is input to the machine learning algorithm, the machine learning algorithm classifies the labeled out-of-warranty sensor data as being the out-of-warranty state;
training the machine learning algorithm using the labeled in-warranty sensor data and the labeled out-of-warranty sensor data.

14. The electronic device of claim 8 further comprises:
the circuitry determining that the sensor data satisfies a threshold value; and
thereafter, the circuitry performing the classification of the sensor data.

15. The electronic device of claim 8 wherein the one or more sensors comprise at least one of an accelerometer, a magnetometer, a proximity sensor, a gyro, a temperature sensor, a barometer, application data, a microphone, a touch screen sensor a pressure sensor, and a biometric sensor.
